(19) United States
(12) Patent Application Publication
(10) Pub. No.: US 2001/0055639 A1
(43) Pub. Date: Dec. 27, 2001

(54) Granular product

(76) Inventors: Tassilo Moritz, Freiberg (DE); Teja Reetz, Schoneiche (DE); Klaus Deller, Hainburg (DE); Andreas Gutsch, Ranstadt (DE); Michael Kramer, Maintal (DE); Gunther Michael, Karlstein (DE)

Correspondence Address: PILLSBURY WINTHROP LLP, 1600 TYSONS BOULEVARD, MCLEAN, VA, 22102, US

(21) Appl. No.: 09/810,517

(22) Filed: Mar. 19, 2001

(30) Foreign Application Priority Data
Mar. 18, 2000 (EP) 00 105 808

(51) Int. Cl. A23P 1/06

(52) U.S. Cl. 426/384; 426/385

(57) ABSTRACT

Granular products with individual granules with virtually spherical particles of a homogeneous density distribution are produced by converting solids into suspensions, atomizing the suspensions and drying them by sublimation drying.

### This application claims priority from EPC Application No. 00105808, filed on Mar. 18, 2001, the subject matter of which is hereby incorporated herein by reference.

### BACKGROUND OF THE INVENTION

1. Field of the Invention

This invention relates to a granular product, to a process for the production thereof and to the use thereof.

2. Background Information

Very finely divided solids offer, thanks to their large specific surface area and small primary particle size, a series of advantageous properties such as for example elevated adsorption capacity, elevated chemical reactivity, high sintering activity and, in the case of ceramic powders, very finely divided microstructural features, which may bring about an increase in strength in the component. Finely divided solids are furthermore frequently used as functional fillers in the lacquers, coatings etc. sector.

A disadvantage from the handling standpoint, however, is that as solid particle size falls, handling becomes considerably more difficult. The solids are usually in agglomerated form and have poor flowability as a powder or, in the event that they are in suspended form, they cannot be converted into a redispersible dry powder using known methods.

In dry powder form, finely divided solids generate considerable problems during transport, conveying and storage operations and during dry and wet shaping by pressing, wet granulation or extrusion. It is precisely with very fine, sinter-active powder that it is very difficult to avoid non-uniformity of packing during shaping, such that the probability of the occurrence of defects increases sharply with powder fineness (Oberacker, R.; Agniel, Y.; Thümmler, F.: Pulvermetallurgie in Wissenschaft und Praxis, vol. 7, p. 185, VDI-Verlag Düsseldorf, 1991).

If disperse solids are to be handled and further processed, they must be converted into granular products.

The term granulation is here taken to mean the creation of a secondary grain having desired properties from the primary grain which is unsuitable for further processing due to its fineness (Gottschalk, A.: Keramische Zeitschrift, 38 (1986) 4, pp. 184-186).

Granular products are intermediates in the shaping process which substantially influence the physical and mechanical properties of a solid (Ingenerf, G.: Keramische Zeitschrift, 48 (1996) 4, pp. 315-317).

If further processing is to be industrially feasible, it is thus essential to perform granulation (Matje, P.; Martin, K. P.; Schetz, K. A.: Keramische Zeitschrift, 38 (1986) 4, p. 189). Granular product properties which are ideal for further processing on subsequent pressing or extrusion and sintering are determined by:

good flowability,

elevated bulk density, p1 reproducible moisture content, p1 maximally uniform, constant and not excessively coarse grain,

absence of dust,

elastic deformability of the individual granules at their contact points during transport and storage and

complete destructibility in the compression mould.

The primary condition for good flowability is a virtually spherical shape of the particles of the granular product.

Spray drying is probably the most widely used granulation process for producing pressing granules in the ceramics industry. Spraying a ceramic slip with simultaneous evaporative drying of the liquid phase results in granules of a spherical shape which exhibit both good flowability and a sufficiently high bulk density. The frequently encountered hollow spherical shape and elevated hardness of the granules are disadvantageous. These properties mean that spray-dried granules require elevated compression pressures during shaping in order to ensure that the hollow spheres are completely destroyed and the cavities are filled with fragments. Incompletely destroyed granules leave distinct grain boundaries in the green compact which have a negative impact in particular on the sintering operation (Mazanek, J.; Gizycki, U. v.; Khwaja, Z.: cfi/Ber. DKG, 70 (1993) 6, pp. 272-274; Shaw, F. V.: Am. Ceram. Soc. Bull. 79 (1990) 9, pp. 1484-89). Moreover, if the granular products are excessively dry, considerable elastic relaxation occurs after pressing due to the brittle/elastic behaviour of the grains.

The stated disadvantages of hollow sphere formation are avoided by accretion granulation. This process is performed either as fluidised bed granulation (Schöps, W.; Beer, H.: DKG annual conference 1993, short papers, Weimar, Oct. 6-8, 1993, pp. 276-278) or by mechanical rolling of preformed seed granules in a powder bed. In the latter case, granules are obtained with a distinct surface texture which, on exposure to pressure, results in flakes of the accreted layers peeling off. Fluidised bed granulation gives rise to rounded, irregularly shaped granules of a compact structure (Ingenerf, G.: Keramische Zeitschrift, 48 (1996) 4, pp. 315-317). Despite the non-spherical shape, good flowability and compression mouldability are emphasised (Voigt, M.; Herrmann, J.; Böber, R.; Wand, B.; Witschel, H.; Seege, A.: Keramische Zeitschrift, 43 (1991) 2, pp. 87-89). The relatively high compressive strength of fluidised bed granules may have a negative impact on the shaping process and result in elevated residual porosity in the green compact.

The binding mechanisms underlying the mechanical strength of the granules produced using known processes are, firstly, capillary forces, which come into play as a result of vaporisation of the suspending liquid and may bond the solid particles together very strongly.

Bonds may also be created by solid bridges of crystallising additives or highly viscous binders or by organic macromolecules. Especially in non-thermal, mechanical granulation processes, such as compacting, interlocking bonds due to particle entanglement are also observed.

In applications in which redispersion of the granular products is required, the above-stated binding mechanisms are generally too strong. In particular in the case of finely divided solids, the primary particle size of which is in the nanometer range, it has been observed that the above-stated shaping methods give rise to the formation of solid bridges because the particles may exhibit solubility in the suspending matrix due to their elevated specific surface area. Redispersion to achieve a particle size distribution matching that of the starting solids thus usually cannot be achieved or may be achieved only by means of an extremely high energy input.

If a completely redispersible granular product is to be obtained, weaker bond forces must apply between the primary particles. Sublimation drying or freeze drying, a process in which a deep-frozen material is dried by subliming the solvent under a vacuum, is an option in this case. Since the liquid phase is in the solid state during freeze drying, no capillary forces come into effect during sublimation. The particles do not come closer together and hard agglomerates are thus not obtained (Hausner, H.: Fortschrittsberichte DKG, 8 (1993), pp. 107-121).

In granular products from which the suspending medium has been removed by freeze drying, only van der Waals forces or electrostatic forces come into effect, provided that no auxiliaries which result in the formation of material bridges are added to the suspensions.

Van der Waals forces apply as a result of the electric dipole moments of atoms and molecules. These forces have a very short range. Electrostatic forces are determined by particles with charges of a different sign. Differing charges may already be present as an excess charge or may arise by electron transfer when solids come into contact (contact potential). In electrical non-conductors, the absorbed charges are located in surface layers to a depth of up to 1 μm. The effectiveness of van der Waals forces as a binding mechanism is decisively determined by primary particle size and, assuming a material density of 3 g/cm3, these forces exceed the competing effect of gravity only in particles of <100 μm. In other words, this binding mechanism cannot effect granulation in larger particles (Bartusch, R.: Das Keramiker-Jahrbuch 1998, p. 24, Bauverlag, Wiesbaden & Berlin).

### SUMMARY OF THE INVENTION

It is an object of the invention to provide a granular product which is virtually spherical and thus has very good flowability, the individual granules of which exhibit a homogeneous structure, and which may be completely redispersed on application of the dispersion conditions required to disperse the starting solid.

The invention provides a granular product prepared from disperse, finely divided solids having primary particle sizes of less than 10 μm, characterised in that the individual granules constitute virtually spherical particles of a homogeneous density distribution, which may be completely redispersed under the dispersion conditions used for the starting solids.

This granular product is distinguished by excellent flowability, very low individual granule strength and complete redispersibility under the dispersion conditions used for the starting solids.

The rate of freezing of the suspension plays a decisive role in ensuring complete redispersibility of the granular product. Only the combination of freeze drying with spray freezing prevents the formation of stronger contact between particles which obstructs resdispersion. A slower method of freezing the unsubdivided suspension, for example by pouring liquid nitrogen over the suspension (Reetz, T.; Moritz, T.: published patent application DE 41 18 752 A1 (1992)), does not result in the desired complete redispersibility.

The starting solid used for the production of the granular product may comprise not only ceramic and metallic but also polymeric materials as well as carbon blacks.

In a preferred embodiment of the invention, pyrogenically produced oxides and/or mixed oxides of metals and/or metalloids may be used as starting materials. These in particular comprise pyrogenically produced TiO₂, SiO₂, Al₂O₃ and the mixed oxides thereof. These substances are described in Ullmann's Enzyklopädie der technischen Chemie, 4^{th} edition, volume 21, page 464 (1982).

They may be produced by hydrolysing a volatilisable compound of a metal or metalloid by means of an oxyhydrogen flame. The volatilisable compound used may, for example, comprise the corresponding chlorides or methyl chlorides.

Such oxides may, for example, be Aerosil OX 50, titanium dioxide P 25. In another embodiment of the invention, carbon black may be used as the starting material.

The disperse, finely divided solids may initially assume the form of dry or moist powders.

The invention also provides a process for the production of the granular product, which process is characterised in that the finely divided solids are converted into flowable suspensions, these suspensions are subdivided using a suitable atomisation technique, are frozen as a disperse collective and then dried by sublimation drying with exclusion of the action of capillary forces.

Subdivision of flowable suspensions by means of spray nozzles or rotating disks generates particle size distributions which directly influence the size distribution of the granules. Once the atomised suspension with droplet sizes of between 50 and 500 μm has been frozen in a cooling liquid or cold stream of gas, the granule shape and size is already determined. No further compaction of the material occurs on subsequent freeze drying. The shape of the granules likewise remains unchanged. After drying, the adhesive forces prevailing within the individual granules ensure the cohesion of the primary particles.

Due to the surface tension of the suspending medium, the spray droplets assume a spherical shape, which is retained in the granular product. The density of the individual granules is determined by the solids content of the suspension. The granules have a homogeneous particle packing.

Redispersing granular products in which these weak adhesive forces apply thus requires no greater energy input than is required to disperse the starting solids. If, as a result of the production process, the starting powder contains agglomerates which exhibit stronger binding forces, the energy input for redispersing these primary agglomerates may even be even lower.

Various organic and/or inorganic solvents, in particular water, may be used to produce the suspensions.

Cooling media which may be used are cryogenic liquefied gases and/or cryogenic liquids.

### DETAILED DESCRIPTION OF THE INVENTION

### EXAMPLE 1

A suspension with a solids content of 30 wt. % is prepared by stirring a highly disperse TiO₂ powder (P 25, Degussa-Huels) into water. The suspension is stabilised with the dispersion auxiliary Dolapix CA (Zschimmer & Schwarz, Lahnstein).

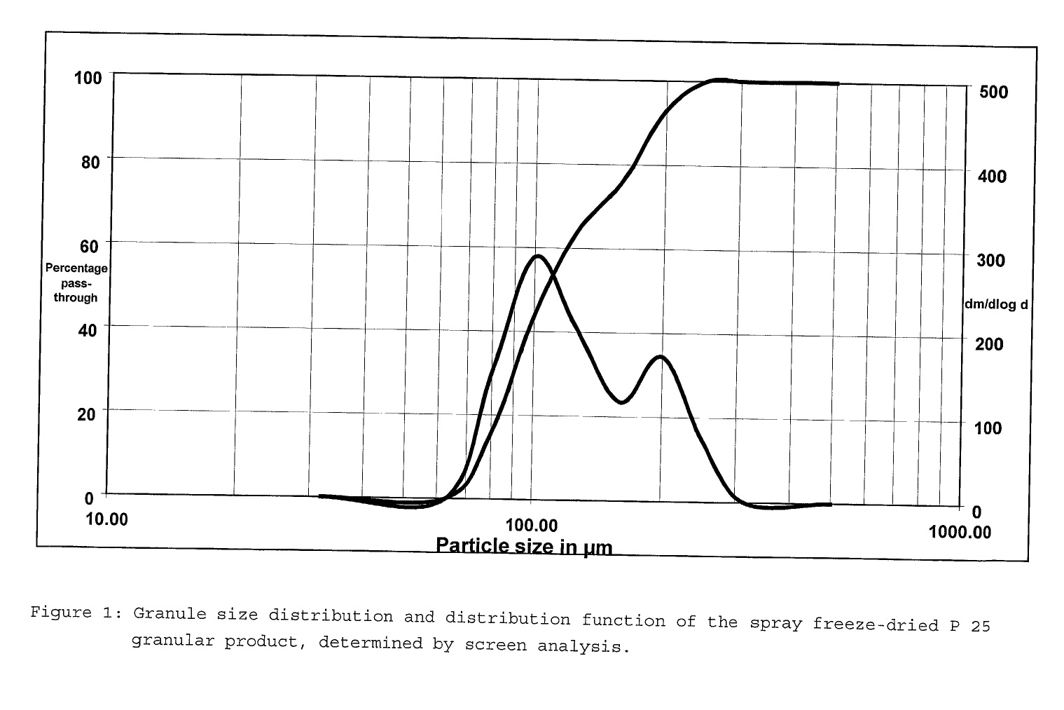

The suspension is then sprayed by means of a two-fluid nozzle (ø=1 mm) into liquid nitrogen and instantaneously frozen. After subsequent freeze drying, a granular product having very good flowability is obtained. The granule size distribution of the resultant granular product is shown in FIG. 1. The bulk density of the granular product is approx. 300 g/l.

The granules are very soft, but are not destroyed during storage and handling.

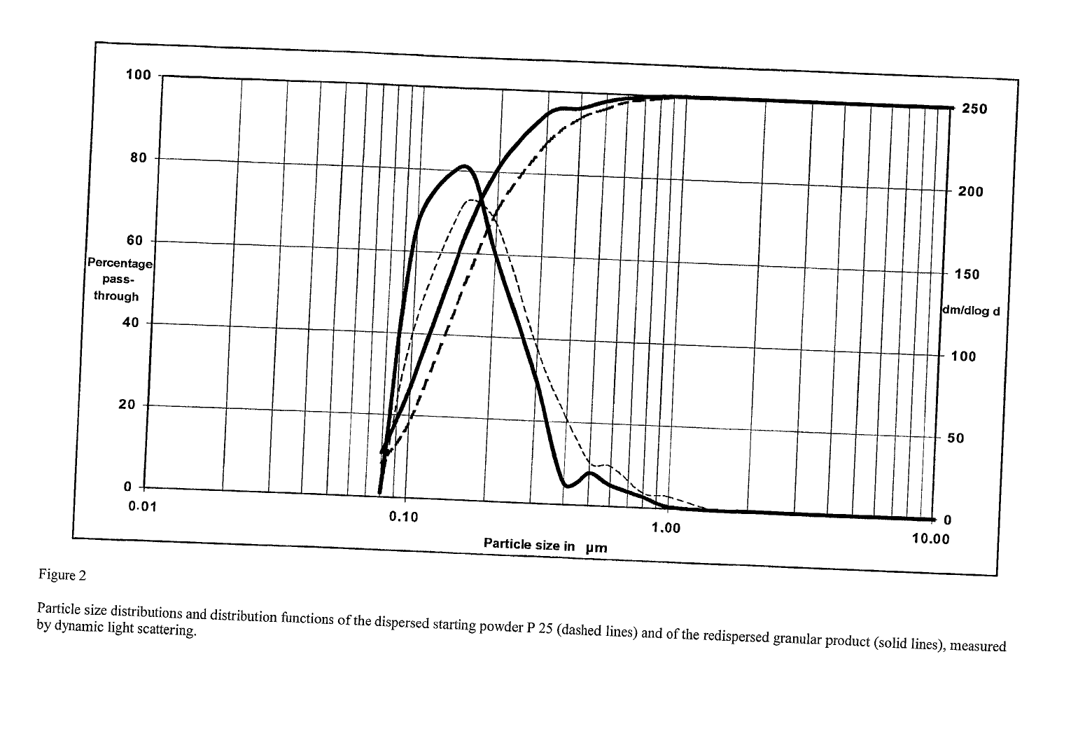

In order to investigate redispersibility, 200 mg of the starting powder and of the granular product are stirred for 15 minutes with a magnetic stirrer in 100 ml portions of water and are additionally treated for 12 minutes in an ultrasound bath and for 30 s with an ultrasound probe. Particle size distributions are then determined by dynamic light scattering (UPA, Leeds & Northrup). Surprisingly, both particle size distributions are comparable (FIG. 2). There is no sign of undestroyed agglomerates which indicates both complete dispersion of the starting powder and complete redispersion of the granular product.

Incompletely destroyed powder agglomerates are still evident in both cases when the two materials are treated by stirring without additional exposure to ultrasound.

### EXAMPLE 2

A highly disperse SiO₂ powder Aerosil OX 50 (Degussa-Hüls), which was produced pyrogenically, is processed into an aqueous suspension with a solids content of 25 wt. % and converted into a granular product by spraying by means of a two-fluid nozzle (ø=1.5 mm) into liquid nitrogen and subsequent freeze drying. The granule size distribution is determined by screen analysis. The median particle size by volume of the particle size distribution is 315 μm.

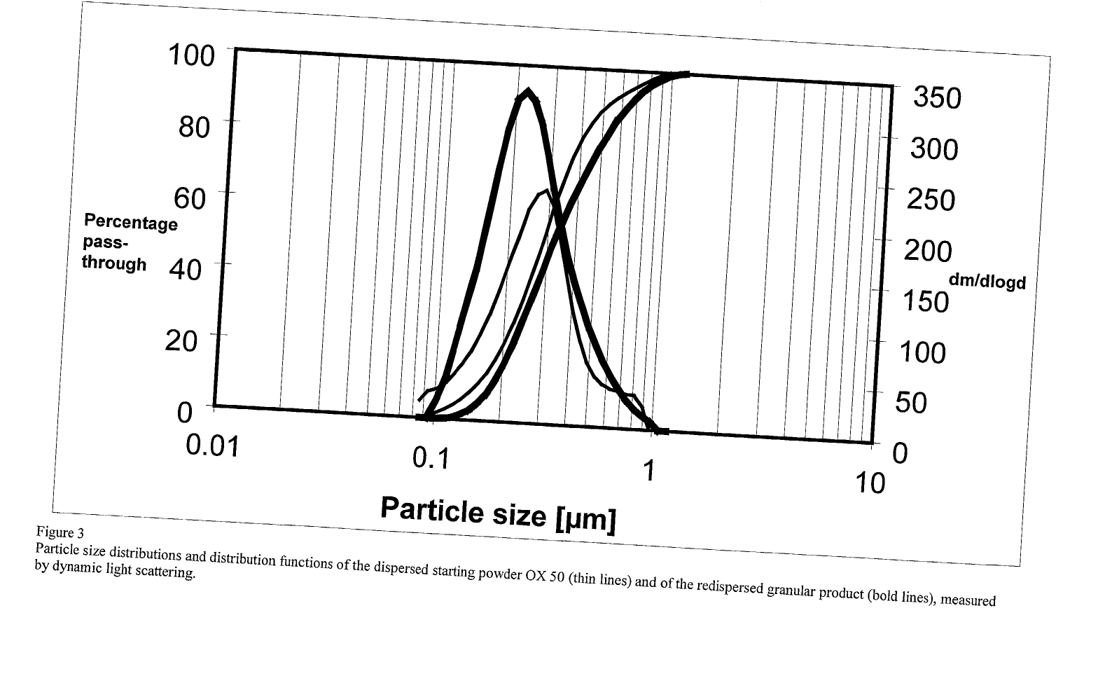

One particle fraction (80-250 μm) of the resultant granular product is used to investigate redispersion. The granular product fraction is here prepared in the same manner as the starting powder which is to be dispersed. 200 mg portions of the granular product fraction and of the powder Aerosil OX 50 are stirred into 100 ml of water. The duration of stirring is 15 min. The dispersions are then treated for 12 min in an ultrasound bath and additionally for 4 minutes with an ultrasound probe. The particle size distributions determined by dynamic light scattering (UPA, Leeds & Northrup) (FIG. 3) prove that the granular product fraction may be completely redispersed under the conditions used. The particle size distribution is virtually identical to that of the starting powder.

What is claimed is:

1. A granular product prepared from disperse, finely divided solids having primary particle sizes of less than 10 μm, wherein individual granules of said product are virtually spherical particles of a homogeneous density distribution, which may be completely redispersed under the dispersion conditions used for the starting solids.

2. A process for the production of a granular product according to claim 1, wherein the finely divided solids are converted into flowable suspensions, the suspensions are subdivided using atomisation, are frozen as a disperse collective and then dried by sublimation drying with exclusion of the action of capillary forces.
